(19) United States
(12) Patent Application Publication
(10) Pub. No.: US 2013/0179344 A1
(43) Pub. Date: Jul. 11, 2013

(54) METHOD OF PROCESSING PAYMENTS

(71) Applicants: Frank Georgoulas, Queensland (AU); Paul Beet, Queensland (AU)

(72) Inventors: Frank Georgoulas, Queensland (AU); Paul Beet, Queensland (AU)

(73) Assignee: ARTISTS KNOWN AS PTY. LTD., Victoria (AU)

(21) Appl. No.: 13/641,183

(22) PCT Filed: Apr. 18, 2011
(86) PCT No.: PCT/AU11/00437

§ 371 Date: Mar. 4, 2013

(30) Foreign Application Priority Data
Apr. 16, 2010 (AU) 2010901615

(51) Int. Cl. G06Q 20/32

(52) U.S. Cl. CPC G06Q 20/3226
USPC 705/44

(57) ABSTRACT

A method allowing a customer having registered payment account details with a service or product provider to place a purchase order and pay for a product or a service using a networked device such as a mobile phone. The customer may send, for example in a short messaging service (SMS) message, a product or service identifier identifying the product or the service to a designated telephone number to initiate a purchase. The identifier may for instance be an alphanumeric codeword included in an advertisement or a catalogue promoting the product or the service. In one embodiment, the purchase order system is a computer programme or software implemented as an application programming interface (API), which may be able to interface with a website of the product or service provider as well as communicating with a plurality of payment gateways.

### FIELD OF THE INVENTION

The present invention relates generally to a method of processing payments, and particularly to a method of processing payments initiated by a networked device.

### BACKGROUND OF THE INVENTION

When purchasing a product or a service from a product or service provider, a customer is usually offered to pay for the product or service by a number of payment methods. These payment methods include cash and electronic means such a credit card, a debit card or a bank card. With electronic means, payments are usually processed by a terminal (known as the Electronic Funds Transfer at Point of Sale or EFTPOS terminal) located at the premises of the product or service provider.

At times a potential customer may wish to purchase a product or service whilst they are not at the premises of the product or service provider. For example, a potential customer may see or hear an advertisement of the product or service on radio, television, billboards or in newspapers or catalogues when they are at home or travelling on a bus, train or ferry. In such circumstances, it may be inconvenient, difficult or impossible to process a payment for the product or the service via an EFTPOS terminal as the potential customer may not be at or near the premises of the product or service provider. Because the potential customer is unable to pay for (and thus make a purchase of) the product or the service at the moment they wish to, they may later forget or have less interest to do so. This inability of the potential customer to pay instantly or almost instantly may well cause the product or service provider to lose this potential customer.

### SUMMARY OF THE INVENTION

According to a first aspect of the present invention there is provided a method of processing a payment for a product or a service, the method comprising the steps of:
(i) associating a customer identifier with a payment account associated with a verification code;
(ii) receiving from a networked device the customer identifier and a product or service identifier identifying the product or the service;
(iii) receiving from the networked device an authorisation code;
(iv) determining if the received authorisation code matches the verification code; and
(v) if the authorisation code is determined to match the verification code, facilitating payment for the product or the service via the payment account.

Preferably the step of receiving the customer identifier and a product or service identifier includes the step of receiving the customer identifier and a product or service identifier via a short messaging service (SMS). Alternatively the step of receiving the customer identifier and a product or service identifier includes the step of receiving the customer identifier and a product or service identifier via access of a predetermined universal resource locator (URL) or web address by the networked device.

Preferably the step of receiving an authorisation code includes the step of receiving an authorisation code via the SMS.

Preferably the step of associating a customer identifier with a payment account associated with a verification code includes the step of storing the customer identifier, information of the payment account and the verification code as stored customer identifier, stored payment account information and stored verification code, respectively.

Preferably the method further comprises the step of determining if the received customer identifier is one of one or more associated customer identifiers. More preferably if the received customer identifier is determined not to be any one of the one or more associated customer identifiers, the step of associating a customer identifier with a payment account occurs after the step of receiving the customer identifier and a product or service identifier.

Preferably the method further comprises the step of determining if the received product or service identifier is one of one or more valid product or service identifiers. More preferably if the received product or service identifier is determined to be one of the one or more valid product or service identifiers, the method further comprises the step of sending particulars of the product or the service to the networked device. Even more preferably the step of sending particulars of the product or the service includes the step of sending any one or more of description, price information, quantity and images of the product or the service.

Preferably the step of sending particulars of the product or the service includes the step of sending particulars of the product or the service via any one or more of the SMS, multimedia messaging service (MMS) or email.

Preferably if the received product or service identifier is determined to be one of the one or more valid product or service identifiers, the method further comprises the step of identifying the product or the service as requiring the payment. More preferably the step of identifying the product or the service as requiring the payment includes the step of placing the product or the service in an electronic shopping basket. Alternatively or additionally the step of identifying the product or the service as requiring the payment includes the step of sending a request for confirming purchase of the product or the service to the networked device. Even more preferably the step of sending a request for confirming purchase includes the step of sending a request for the authorisation code to the networked device.

Preferably the step of sending a request for confirming purchase includes the step of sending a request for confirming purchase to the networked device via the SMS, the MMS, or email.

Preferably if the received product or service identifier is determined not to be any one of the one or more valid product or service identifiers, the method further comprises the step of sending a notification that the product or service identifier is invalid to the networked device. More preferably the step of sending a notification that the product or service identifier is invalid includes the step of sending a request for re-sending the same or a different product or service identifier.

Preferably the step of sending a notification that the product or service identifier is invalid includes the step of sending the notification via the SMS, the MMS, or email.

Preferably if the received authorisation code matches the verification code, the step of determining includes the step of comparing the received authorisation code with the verification code. More preferably the step of comparing the received authorisation code with the verification code includes the step of comparing the received authorisation code with the stored verification code. Alternatively the step of determining if the received authorisation code matches the verification code includes the step of sending the received authorisation code to a payment gateway for determination.

Preferably if the received authorisation code is determined not to match the verification code, the method further comprises the step of sending a request for re-sending the same or a different authorisation code to the networked device. More preferably the step of sending a request for re-sending the same or a different authorisation code includes step of sending a request for re-sending the same or a different authorisation code via the SMS, the MMS or email.

Preferably the method further comprises the steps of:
(i) associating the customer identifier with one or more additional payment accounts associated with one or more respective additional verification codes;
(ii) determining if the received authorisation code matches any one of the additional verification codes; and
(iii) if the received authorisation code is determined to match one of the additional verification codes, facilitating the payment for the product or the service via the additional payment account associated with the matched additional verification code.

More preferably if the received authorisation code is determined not to match any one of the additional verification codes, the method further comprises the step of sending a request for re-sending the same or a different authorisation code to the networked device. Even more preferably the step of sending a request for re-sending the same or a different authorisation code includes the step of sending a request for re-sending the same or a different authorisation code via the SMS, the MMS or email.

Preferably the step of facilitating the payment includes the step of sending the received authorisation code and/or the stored payment account information to a payment gateway for authorising the payment. More preferably the step of facilitating the payment includes the step of receiving from the payment gateway a payment confirmation. Even more preferably the step of facilitating the payment includes the step of sending the payment confirmation to the networked device. Alternatively or additionally the step of facilitating the payment includes the step of sending the payment confirmation to a product or service provider providing the product or the service.

Preferably the step of sending the payment confirmation to the networked device includes the step of sending the payment confirmation to the networked device via the SMS, the MMS, and email.

Preferably the step of sending the payment confirmation to a product or service provider includes the step of sending the payment confirmation to a product or service provider via the SMS, the MMS, and email.

Preferably the networked device and the product or service provider are located in different locations.

Preferably the networked device includes a mobile networked device. More preferably the mobile networked device includes a mobile phone, a cellular phone or a portable computer.

Preferably the customer identifier is adapted to identify a customer purchasing the product or the service.

Preferably the customer identifier includes a mobile network identifier. More preferably the mobile network identifier includes a mobile phone number, a mobile subscriber integrated services digital network (MSISDN) number or an international mobile equipment identity (IMEI) number.

Preferably the customer identifier includes a network address identifier. More preferably the network address identifier includes an email address, a Media Access Control (MAC) address and an Internet Protocol (IP) address.

Preferably the payment account includes a credit card account, a debit card account, a bank account, a PayPal® account, a loyalty program account or a frequent flyer account.

Preferably the verification code or the authorisation code includes any one or more of a personal identification number (PIN), a card verification value (CVV), a card verification code (CVC), an expiry date and an alpha numeric password.

Preferably the product or service identifier is adapted to be provided in an advertisement or a catalogue.

According to a second aspect of the present invention there is provided a machine or computer readable medium with instructions for processing a payment for a product or a service, the instructions being adapted to instruct the machine or computer to carry out the steps of:
(i) associating a customer identifier with a payment account associated with a verification code;
(ii) receiving from a networked device the customer identifier and a product or service identifier identifying the product or the service;
(iii) receiving from the networked device an authorisation code;
(iv) determining if the authorisation code matches the verification code; and
(v) if the authorisation code is determined to match the verification code, facilitating payment for the product or the service via the payment account.

Preferably the instructions are implemented as an application programming interface (API). More preferably the API is adapted to integrate with a website of a product or service provider providing the product or the service.

Preferably the API is adapted to communicate with any one of a plurality of payment gateways.

### BRIEF DESCRIPTION OF THE ACCOMPANYING DRAWINGS

FIG. 1 A diagram illustrating an embodiment of the present invention.

FIG. 2 A tabular representation of an example of an electronic database.

FIG. 3 A tabular representation of an example of a product catalogue.

FIG. 4 A flow chart illustrating an example of the decision making process of a processor.

FIG. 5 A diagram showing an example of data in the database accessible by a product or service providers.

### DETAILED DESCRIPTION OF THE PREFERRED EMBODIMENTS

The method according to the present invention allows a customer who has registered his or her details, such as information of a payment account, with a service or product provider to place a purchase order and pay for a product or a service using his or her networked device such as a mobile phone. The customer may simply send, for example in a short messaging service (SMS) message, a product or service identifier identifying the product or the service to a designated telephone number to initiate a purchase. The product or service identifier may for instance be an alphanumeric codeword included in an advertisement or a catalogue promoting the product or the service. This method allows a payment to be processed even if the networked device and the product or service provider are located in different locations.

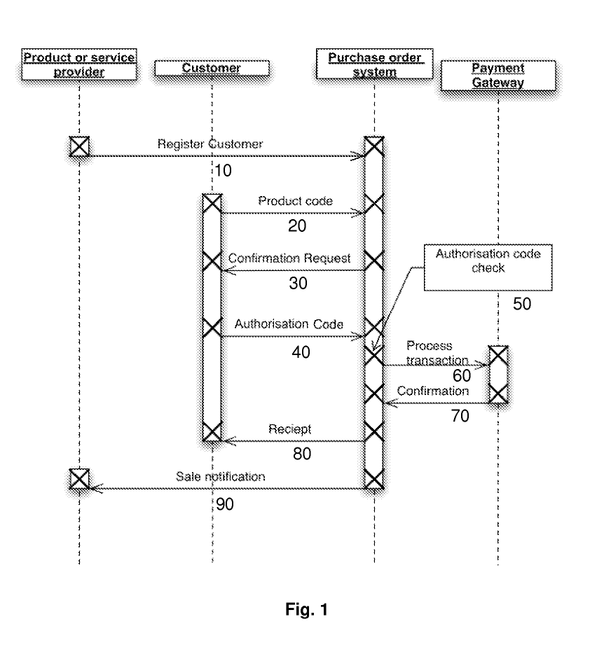

FIG. 1 illustrates the steps of an embodiment of the method, which involves a product or service provider, a customer, a purchase order system (which carries out the method) and a payment gateway. In one embodiment, the purchase order system is a computer programme or software implemented as an application programming interface (API), which may be able to interface with a website of the product or service provider. Additionally the API may be able to communicate with a plurality of payment gateways (simultaneously or individually), which ideally includes any payment gateway or merchant gateway in the world. The purchase order system may be connected to a communications network, such as a mobile phone network or the Internet, to send and receive SMS messages, multimedia messaging service (MMS) messages and emails.

### Registration

The method may begin with a customer registration step 10 by associating a customer identifier, such as a mobile phone number of the customer, with a payment account, such as a credit card account of the customer. The customer identifier should be able to identify the customer who places a purchase order. The customer identifier and the associated payment account information, including an associated verification code such as a card verification value (CVV) code, may be stored in an electronic database physically located in a computer or any data storage means.

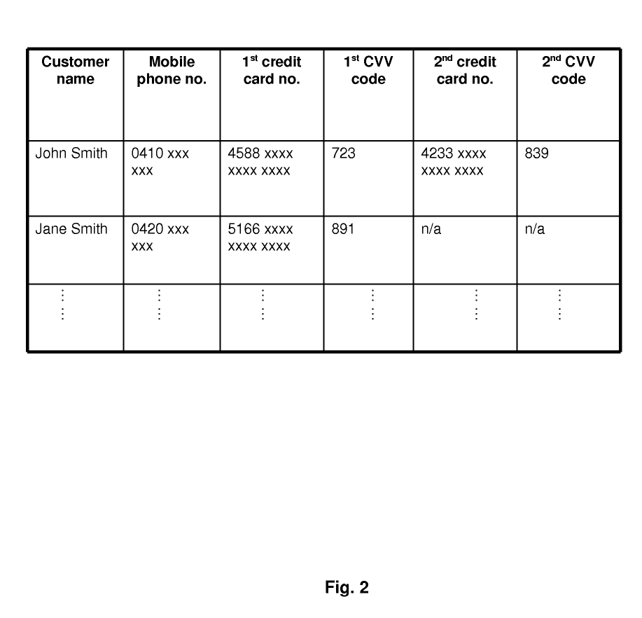

FIG. 2 shows a tabular representation of the information, such as the customer name and an associated mobile phone number, an associated credit card account number with an associated CVV code, that may be stored in the electronic database. As illustrated in FIG. 2, a customer (John Smith) may register one or more additional payment accounts to be associated with his or her mobile phone number. Each of the additional payment accounts may be associated with a respective verification code.

### Initiating a Purchase and Placing a Purchase Order

When the customer sees an advertisement, which may read “Text product code ‘W2’ to 133 246 to buy this digital camera for $200”, the customer at step 20 may initiate a purchase of the advertised product by sending from his or her mobile phone a SMS message with the product or service identifier “W2” to the designated telephone number of 133 246. Since a SMS message header often includes the sender's mobile phone number, the customer's mobile phone number together with the product or service identifier “W2” may be received by the product or service provider's purchase order system. The purchase order system, which may retrieve information from the electronic database and a product catalogue that identifies “W2” as referring to the associated advertised product, may identify a purchase order of a digital camera being placed by a particular customer. The purchase order system may then identify the digital camera as requiring payment by the particular customer by placing the digital camera in an electronic shopping basket of the customer.

Alternatively the advertisement may be an online advertisement together with a direct or predetermined universal resource locator (URL) or a web address which, when activated or clicked on, sends an electronic request of a purchase of the advertised product to the purchase order system via the Internet. The purchase order system may therefore receive the product or service identifier by way of the electronic request to identify the product being ordered. The purchase order system may also receive the customer identifier by logging the network address, such as an IP address, from which the electronic request originates to identify the particular customer placing the purchase order. Similar to the SMS ordering method above, the purchase order system may then identify the product being ordered as requiring payment by the particular customer by placing the product being ordered in an electronic shopping basket of the customer.

It is envisaged that a customer may initiate the purchase at step 20 even if the customer has not yet registered, or has not yet had his or her customer identifier associated with a payment account at step 10. For example, after receiving a product or service identifier from an unregistered mobile phone number, the purchase order system may determine that the received mobile phone number is not any one of the mobile phone numbers already associated with a payment account in the electronic database. In this case, the registration step 10 may occur after the step 20 of placing the purchase order. For example, the purchase order system may reply with a SMS message to the customer's mobile phone requesting the customer's details, or directing the customer to a website of the product or service product for customer registration.

### Checking for Valid Product or Service Identifier

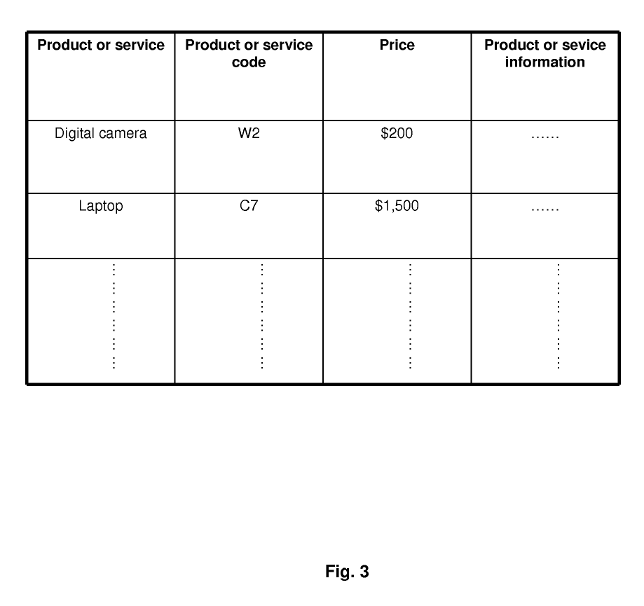

The method may further comprise the step of determining if the received product or service identifier is one of the valid product or service identifiers. This step may involve comparing the received product or service identifier with a list of product or service identifiers in a product catalogue, for example, as shown in FIG. 3. If the received product or service identifier is determined to be one of the valid product or service identifiers (for example, on the product catalogue), the purchase order system may at step 30 (in addition to placing the product or the service in an electronic basket) send particulars of the product or the service, such as description, price information, quantity and images to the customer's mobile phone, via any one or more of the SMS, a multimedia messaging service (MMS), and email.

Step 30 may include sending a request for confirming purchase of the product or the service to the customer's mobile phone. This step of confirming the purchase may involve sending a request, for example in a SMS message, for an authorisation code to provide an indication that the purchase is initiated by the customer (or is authorised by customer). For the purchase order to proceed, the authorisation code should be the same as the verification code associated to the payment account (or any one of the additional verification codes respectively associated to the additional payment accounts) provided at the registration step 10. At step 40 the customer may send from his or her mobile phone, for example, an authorisation code in a SMS message to the purchase order system.

If the received product or service identifier is determined not to be any one of the one or more valid product or service identifiers, the purchase order system may send a notification that the product or service identifier is invalid to the customer's mobile phone. This may involves sending a request for re-sending the same or a different product or service identifier via the SMS, the MMS or email.

### Authorisation Code Check and Processing Payment

At step 50, the purchase order system may determine if the received authorisation code matches the verification code associated with the payment account (or matches any one of the additional verification codes respectively associated to the additional payment accounts). If the received authorisation code is determined to match the verification code (or any one of the additional verification codes), the purchase order system may facilitate payment for the product or the service at step 60 via the payment account (or the additional payment account associated with the matched verification code). Conversely, if the received authorisation code is determined not to match the verification code (or any one of the additional verification codes), the purchase order system may send a request to the networked device, for example via the SMS, the MMS or email, for re-sending the same or a different authorisation code.

To facilitate payment at step 60, the purchase order system may send the received authorisation code (or verification code, which should have already been determined to match the received authorisation code) and/or the stored payment account information to the payment gateway for authorising the payment for the product or the service. At step 70, if the payment transaction is successful, the purchase order system may receive from the payment gateway a payment confirmation. At step 80, the purchase order system may send the payment confirmation or a receipt to the customer's mobile phone to acknowledge a successful payment. At step 90, the purchase order may send the payment confirmation or a sale notification to the product or service provider, who can then dispatch the product or the service ordered by the customer.

Determining if the received authorisation code matches the verification code (or any one of the additional verification codes) may involve comparing the received authorisation code with the verification code (or any one of the additional verification codes) stored in the electronic database. Alternatively this may involve sending the received authorisation code to the payment gateway for determination. In other words, without comparing the received authorisation code with the verification code (or any one of the additional verification codes), the purchase order system may proceed with step 60. If the purchase order system receives a payment confirmation from the payment gateway, it may indicate a matched verification code (thereby determining if the received authorisation code matches the verification code).

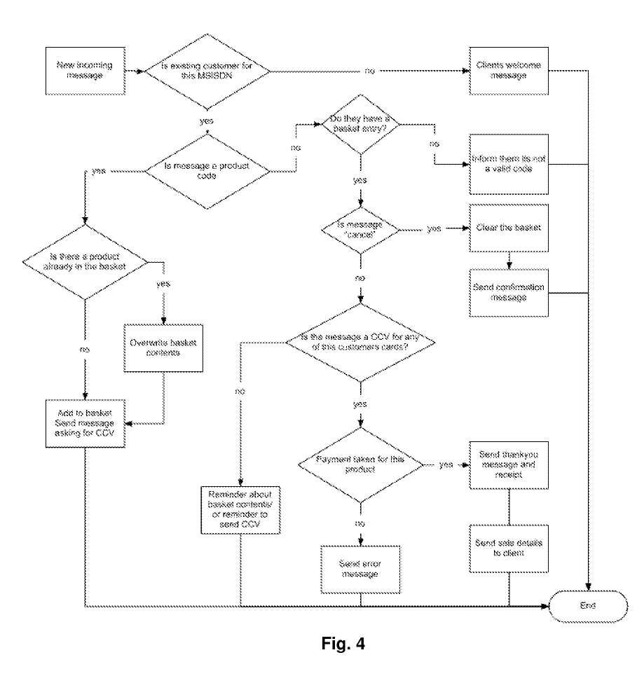

The purchase order system may include a processor for determining the steps and the order in which the steps are to occur, and generating the correct messages, such as replies, requests and notifications to the product or service provider, the customer and the payment gateway. FIG. 4 shows a flow chart illustrating an example of the decision making process of the processor. The decision making process begins with the purchase order system receiving a new incoming message and may end with a number of outcomes, including the purchase order system sending a payment confirmation.

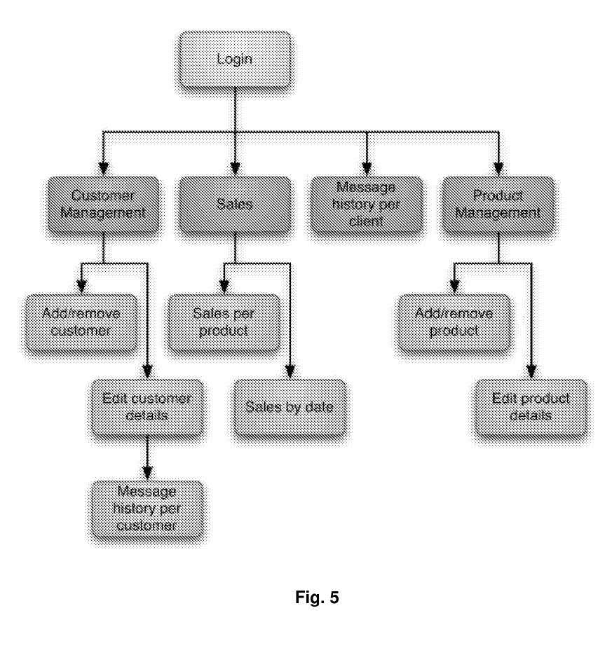

The database may also store the transaction history, message history and sales history (and any data illustrated in FIG. 5) of each customer to retain an audit trail for mitigating risks. The method may provide access for the product or service provider, such as via entering a predetermined username/password combination in a secure website, to at least part of the database such that an audit can be conducted.

Now that the preferred embodiments of the method of processing payments have been described, it should be apparent that the present invention in its preferred embodiments has the following advantages:
It provides convenience to customers who may not reach the premises of a product or service provider to pay for products or services.
Product or service providers are able to improve sales by capturing, for example, impulse buyers who have a greater chance of purchasing a product or a service immediately or shortly after seeing an advertisement of the product or service.
The preferred feature of allowing customers to register multiple payment accounts provides the customers with flexibility to pay via any one of their payment accounts.

It will be appreciated by persons skilled in the art that numerous variations and/or modifications may be made to the invention as shown in the specific embodiments without departing from the spirit or scope of the invention as broadly described. For example, the networked device may include a mobile networked device such as a mobile phone, a cellular phone or a portable computer. The customer identifier may include a mobile network identifier such as a mobile phone number, a mobile subscriber integrated services digital network (MSISDN) number or an international mobile equipment identity (IMEI) number. Alternatively the customer identifier may include a network address identifier such as an email address, a Media Access Control (MAC) address or an Internet Protocol (IP) address. The payment account may include a credit card account, a debit card account, a bank account, a PayPal® account, a loyalty program account or a frequent flyer account. The messages, replies, requests or notifications may be sent or received via the SMS, the MMS or email. The verification code or the authorisation code includes any one or more of a personal identification number (PIN), a card verification value (CVV), a card verification code (CVC), an expiry date or an alpha numeric password.

The present embodiments are, therefore, to be considered in all respects as illustrative and not restrictive.

1. A method of processing a payment for a product or a service, the method comprising the steps of:
associating a customer identifier with a payment account associated with a verification code;
receiving from a networked device the customer identifier and a product or service identifier identifying the product or the service;
receiving from the networked device an authorisation code;
determining if the received authorisation code matches the verification code; and
if the authorisation code is determined to match the verification code, facilitating payment for the product or the service via the payment account.

2. The method as claimed in claim 1, wherein the step of receiving the customer identifier and a product or service identifier includes the step of receiving the customer identifier and a product or service identifier via a short messaging service (SMS).

3. The method as claimed in claim 1, wherein the step of receiving the customer identifier and a product or service identifier includes the step of receiving the customer identifier and a product or service identifier via access of a predetermined universal resource locator (URL) or web address by the networked device.

4. The method as claimed in claim 1, wherein the step of receiving an authorisation code includes the step of receiving an authorisation code via the SMS.

5. The method as claimed in claim 1, wherein the step of associating a customer identifier with a payment account associated with a verification code includes the step of storing the customer identifier, information of the payment account and the verification code as stored customer identifier, stored payment account information and stored verification code, respectively.

6. The method as claimed in claim 1, wherein further
comprising the step of determining if the received customer identifier is one of one or more associated customer identifiers.

7. The method as claimed in claim 6, wherein if the received customer identifier is determined not to be any one of the one or more associated customer identifiers, the step of associating a customer identifier with a payment account occurs after the step of receiving the customer identifier and a product or service identifier.

8. The method as claimed in claim 1, wherein further comprising the step of determining if the received product or service identifier is one of one or more valid product or service identifiers.

9. The method as claimed in claim 9, wherein if the received product or service identifier is determined to be one of the one or more valid product or service identifiers, the method further comprises the step of sending particulars of the product or the service to the networked device.

10. The method as claimed in claim 9, wherein the step of sending particulars of the product or the service includes the step of sending any one or more of description, price information, quantity and images of the product or the service.

11. The method as claimed in claim 9, wherein the step of sending particulars of the product or the service includes the step of sending particulars of the product or the service via any one or more of the SMS, multimedia messaging service (MMS) or email.

12. The method as claimed in claim 8, wherein if the received product or service identifier is determined to be one of the one or more valid product or service identifiers, the method further comprises the step of identifying the product or the service as requiring the payment.

13. The method as claimed in claim 12, wherein the step of identifying the product or the service as requiring the payment includes the step of placing the product or the service in an electronic shopping basket.

14. The method as claimed in claim 12, wherein the step of identifying the product or the service as requiring the payment includes the step of sending a request for confirming purchase of the product or the service to the networked device.

15. The method as claimed in claim 14, wherein the step of sending a request for confirming purchase includes the step of sending a request for the authorisation code to the networked device.

16. The method as claimed in claim 14, wherein the step of sending a request for confirming purchase includes the step of sending a request for confirming purchase to the networked device via the SMS, the MMS, or email.

17. The method as claimed in claim 8, wherein if the received product or service identifier is determined not to be any one of the one or more valid product or service identifiers, the method further comprises the step of sending a notification that the product or service identifier is invalid to the networked device.

18. The method as claimed in claim 17, wherein the step of sending a notification that the product or service identifier is invalid includes the step of sending a request for re-sending the same or a different product or service identifier.

19. The method as claimed in claim 17, wherein the step of sending a notification that the product or service identifier is invalid includes the step of sending the notification via the SMS, the MMS, or email.

20. The method as claimed in claim 1, wherein if the received authorisation code matches the verification code, the step of determining includes the step of comparing the received authorisation code with the verification code.

21. The method as claimed in claim 20, wherein the step of comparing the received authorisation code with the verification code includes the step of comparing the received authorisation code with the stored verification code.

22. The method as claimed in claim 20, wherein the step of determining if the received authorisation code matches the verification code includes the step of sending the received authorisation code to a payment gateway for determination.

23. The method as claim in claim 1, wherein the received authorisation code is determined not to match the verification code, the method further comprises the step of sending a request for re-sending the same or a different authorisation code to the networked device.

24. The method as claimed in claim 23, wherein the step of sending a request for re-sending the same or a different authorisation code includes step of sending a request for re-sending the same or a different authorisation code via the SMS, the MMS or email.

25. The method as claimed in claim 1, further comprising the steps of:
associating the customer identifier with one or more additional payment accounts associated with one or more respective additional verification codes;
determining if the received authorisation code matches any one of the additional verification codes; and
if the received authorisation code is determined to match one of the additional verification codes, facilitating the payment for the product or the service via the additional payment account associated with the matched additional verification code.

26. The method as claimed in claim 25, wherein if the received authorisation code is determined not to match any one of the additional verification codes, the method further comprises the step of sending a request for re-sending the same or a different authorisation code to the networked device.

27. The method as claimed in claim 26, wherein the step of sending a request for re-sending the same or a different authorisation code includes the step of sending a request for re-sending the same or a different authorisation code via the SMS, the MMS or email.

28. The method as claimed in claim 1, wherein the step of facilitating the payment includes the step of sending the received authorisation code and/or the stored payment account information to a payment gateway for authorising the payment.

29. The method as claimed in claim 28, wherein the step of facilitating the payment includes the step of receiving from the payment gateway a payment confirmation.

30. The method as claimed in claim 29, wherein the step of facilitating the payment includes the step of sending the payment confirmation to the networked device.

31. The method as claimed in claim 29, wherein the step of facilitating the payment includes the step of sending the payment confirmation to a product or service provider providing the product or the service.

32. The method as claimed in claim 30, wherein the step of sending the payment confirmation to the networked device includes the step of sending the payment confirmation to the networked device via the SMS, the MMS, and email.

33. The method as claimed in claim 31, wherein the step of sending the payment confirmation to a product or service provider includes the step of sending the payment confirmation to a product or service provider via the SMS, the MMS, and email.

34. The method as claimed in claim 1, wherein the networked device and the product or service provider are located in different locations.

35. The method as claimed in claim 1, wherein the networked device includes a mobile networked device.

36. The method as claimed in claim 35, wherein the mobile networked device includes a mobile phone, a cellular phone or a portable computer.

37. The method as claimed in claim 1, wherein the customer identifier is adapted to identify a customer purchasing the product or the service.

38. The method as claimed in claim 1, wherein the customer identifier includes a mobile network identifier.

39. The method as claimed in claim 38, wherein the mobile network identifier includes a mobile phone number, a mobile subscriber integrated services digital network (MSISDN) number or an international mobile equipment identity (IMEI) number.

40. The method as claimed in claim 1, wherein the customer identifier includes a network address identifier.

41. The method as claimed in claim 1, wherein the network address identifier includes an email address, a Media Access Control (MAC) address and an Internet Protocol (IP) address.

42. The method as claimed in claim 1, wherein the payment account includes a credit card account, a debit card account, a bank account, a PayPal® account, a loyalty program account or a frequent flyer account.

43. The method as claimed in claim 1, wherein the verification code or the authorisation code includes any one or more of a personal identification number (PIN), a card verification value (CVV), a card verification code (CVC), an expiry date and an alpha numeric password.

44. The method as claimed in claim 1, wherein the product or service identifier is adapted to be provided in an advertisement or a catalogue.

45. A machine or computer readable medium with instructions for processing a payment for a product or a service, the instructions being adapted to instruct the machine or computer to carry out the steps of:
associating a customer identifier with a payment account associated with a verification code;
receiving from a networked device the customer identifier and a product or service identifier identifying the product or the service;
receiving from the networked device an authorisation code;
determining if the authorisation code matches the verification code; and
if the authorisation code is determined to match the verification code, facilitating payment for the product or the service via the payment account.

46. The machine or computer readable medium as claimed in claim 45, wherein the instructions are implemented as an application programming interface (API).

47. The machine or computer readable medium as claimed in claim 46, wherein the API is adapted to integrate with a website of a product or service provider providing the product or the service.

48. The machine or computer readable medium as claimed in claim 46, wherein the API is adapted to communicate with any one of a plurality of payment gateways.
